(19) United States
(12) Patent Application Publication
(10) Pub. No.: US 2015/0310942 A1
(43) Pub. Date: Oct. 29, 2015

(54) ACTUATOR

(71) Applicant: ROLLS-ROYCE PLC, London (GB)

(72) Inventor: Ian Michael BUNCE, Derby (GB)

(21) Appl. No.: 14/646,550

(22) PCT Filed: Dec. 6, 2013
(86) PCT No.: PCT/EP2013/003698

§ 371 Date: May 21, 2015

(30) Foreign Application Priority Data
Dec. 11, 2012 (GB) 1222206.3

(51) Int. Cl. G21C 7/14

(52) U.S. Cl. CPC G21C 7/14

(57) ABSTRACT

A pressure sensitive actuator includes: an actuator member (3), and a pressure sensing arrangement (4, 5, 6) which senses the ambient pressure and moves the actuator member in response thereto.

### FIELD OF THE INVENTION

The present invention relates to a pressure sensitive actuator.

### BACKGROUND OF THE INVENTION

Conventional pressurised water nuclear reactors in civil and military applications use control rod drive motors that are mounted externally to the reactor pressure vessel. The pressure vessel has a closure head that incorporates mounting features for the motors. Recent small reactor designs generally adopt integral reactors in which an aim is to incorporate as much of the equipment in contact with the primary coolant within a single reactor pressure vessel. Control rod drive motors are thus being developed which are capable of withstanding primary coolant conditions and of being installed inside the pressure vessel.

However, with an internally mounted control rod drive motor it is not possible for an outside operator to intervene to connect the motor to the control rod without first lifting the pressure vessel closure head.

Thus it would be desirable to have a mechanism for connecting a drive motor and a control rod which does not require outside intervention.

Indeed, more generally it would be desirable to have an actuator that is responsive to environmental conditions.

### SUMMARY OF THE INVENTION

Accordingly, in a first aspect, the present invention provides a pressure sensitive actuator including:
an actuator member, and
a pressure sensing arrangement which senses the ambient pressure and moves the actuator member in response thereto.

Advantageously, the actuator can thus be used to actuate mechanisms, processes etc. in response to changes in ambient pressure, such as can occur for example inside a reactor pressure vessel, thereby avoiding a need for outside intervention.

The pressure sensitive actuator may have any one or, to the extent that they are compatible, any combination of the following optional features.

Conveniently, the pressure sensing arrangement may include a cylinder, a piston operatively connected to the actuator member, and a volume of gas which is trapped between the cylinder and the piston. The gas can then be compressed by increases in ambient pressure, thereby drawing the piston into the cylinder to in turn move the actuator member.

Such a pressure sensing arrangement may be formed as a simple mechanical apparatus, which can increase robustness and reliability.

The piston may be spring-loaded in the cylinder to bias the piston against movement in the cylinder produced by increases in ambient pressure.

The volume of gas may be trapped between the cylinder and the piston by a bellows arrangement.

In a second aspect, the present invention provides a connection mechanism for operatively connecting a first apparatus to a second apparatus, the mechanism being mountable to the first apparatus and including:
a pressure sensitive actuator according to the first aspect; and
an engagement device which is activatable by movement of the actuator member to engage with the second apparatus such that the apparatuses are operatively connected.

The connection mechanism may have any one or, to the extent that they are compatible, any combination of the following optional features.

The actuator member and the engagement device may be configured such that the engagement device is activated by movement of the actuator member when the ambient pressure exceeds a threshold pressure. Thus the engagement device can be triggered to connect the two apparatuses at the threshold pressure.

For example, one option is for the actuator member to include an actuator rod (which typically extends from and is coaxial with the piston) having one or more angled side faces, the actuator rod being movable in its axial direction such that the side faces bear against one or more corresponding follower faces of the engagement device to move the engagement device into engagement with the second apparatus. In this way, by appropriately positioning and shaping the side faces and follower faces, the engagement device can be triggered at the threshold pressure.

The engagement device may comprise one or more engagement teeth which are outwardly extendable (e.g. outwardly pivotable) to engage with the second apparatus.

One option is for the engagement device to maintain engagement with the second apparatus after the engagement device has been activated, i.e. the operative connection can be maintained even if the ambient pressure falls below the threshold pressure. In other words, the engagement device can be latched in the engaged position.

However, another option is for the engagement device to be deactivatable by movement of the actuator member in the opposite direction to disengage the engagement device from the second apparatus and thereby to operatively disconnect the apparatuses. In this way, if the ambient pressure falls below the threshold pressure, the engagement device can be deactivated. For example, when the pressure sensing arrangement includes the cylinder, the piston, and the volume of trapped gas, the trapped gas can be expanded by decreases in ambient pressure thereby pushing the piston out of the cylinder to move the actuator member in the opposite direction.

Conveniently, the engagement device can be biased against the activation which engages it with the second apparatus. Such a bias can help to prevent accidental activation of the engagement device, and can assist with deactivation of the engagement device. For example, when the engagement device comprises one or more outwardly extendable engagement teeth, the teeth may be spring-loaded to bias the teeth towards a retracted position.

The connection mechanism may have particular utility for connecting a nuclear reactor drive motor and a nuclear reactor control rod. Thus, the first apparatus can be a reactor control rod and the second apparatus can be a control rod drive motor. In this case, the connection mechanism may be mountable to an end of the control rod. The connection mechanism can thus ensure connection of the control rod to the drive motor, without outside intervention, when the reactor vessel pressure exceeds a threshold.

In a third aspect, the present invention provides a reactor control rod carrying a connection mechanism according to the second aspect. In a fourth aspect, the present invention provides a reactor vessel containing one or more control rods according to the third aspect and containing one or more control rod drive motors which are operatively connectable to the control rods by the connection mechanisms.

However, the pressure sensitive actuator of the first aspect may have uses other than in the connection mechanism of the second aspect.

For example, in a fifth aspect, the present invention provides a locking mechanism for locking a closure which closes an opening in a wall, the mechanism being mountable to one of the closure and the wall and including:
a pressure sensitive actuator according to the first aspect; and
a lock which is activatable by movement of the actuator member to lock the closure to the wall when the opening is closed by the closure.

The wall can be a pressurised bulkhead and the closure can be a hatch in the bulkhead. Such a locking mechanism may have particular utility in deep sea submersibles.

In a six aspect, the present invention provides a closure or wall carrying the locking mechanism according to the fifth aspect.

Further optional features of the invention are set out below.

### BRIEF DESCRIPTION OF THE DRAWINGS

Embodiments of the invention will now be described by way of example with reference to the accompanying drawings in which:

FIG. 1 shows schematically a connection mechanism for operatively connecting a nuclear reactor control rod 1 apparatus to a drive motor 2, the mechanism being shown in (a) a disengaged position and (b) an engaged position; and

FIG. 2 shows schematically a locking mechanism for locking a hatch which closes an opening in a bulkhead, the mechanism being shown in (a) a locked position and (b) an unlocked position.

### DETAILED DESCRIPTION AND FURTHER OPTIONAL FEATURES OF THE INVENTION

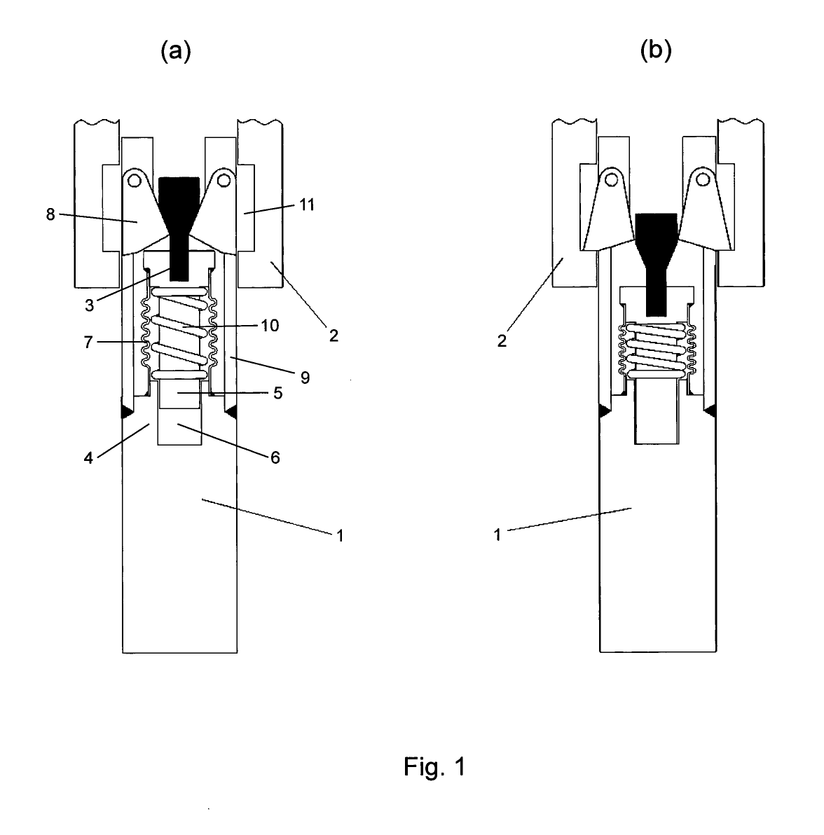

FIG. 1 shows schematically a connection mechanism for operatively connecting a nuclear reactor control rod 1 to a drive motor 2, the mechanism being shown in (a) a disengaged position with the drive motor and (b) an engaged position.

The mechanism includes a pressure sensing arrangement at the upper end of the control rod 1, and an actuating member in the form of an actuator rod 3 which extends upwardly from the control rod and is movable by the pressure sensing arrangement. The pressure sensing arrangement is provided by a cylinder 4 at the end of the control rod, a piston 5 positioned in the cylinder, and a volume 6 of gas (e.g. air) located between faces of the cylinder and the piston. A bellows 7 extends between the piston and the end of the control rod to trap the volume of gas in the cylinder. The piston is slidably movable in the cylinder in the axial direction of the control rod, and carries the actuator rod at its distal end.

The actuator rod 3 has angled side faces which, when the piston 5 and actuator rod move downwards, bear against corresponding follower faces of a pair of engagement teeth 8 which are pivotably connected at opposing sides of an extension 9 to the end of the control rod 1. However, in the extended position of the actuator rod shown in FIG. 1(a), the angled side faces of the actuator rod 3, although just contacting the follower faces of the engagement teeth, have not yet begun to bear on the follower faces. The teeth are therefore retracted into the control rod extension. In this position, the control rod is then disconnected from the drive motor 2, such that operation of the motor cannot result in movement of the control rod.

The piston 5 and actuator rod 3 are biased towards the extended position by a spring 10 which urges the piston upwardly. As the ambient pressure increases, the volume 6 of gas shrinks (following Boyle's law) and the piston 5 is drawn into the cylinder 4 against the action of the spring, moving the actuator rod 3 downwards.

At a threshold ambient pressure, the actuator rod 3 has moved sufficiently downwards that the angled side faces of the actuator rod 3 begin to bear on the follower faces of the engagement teeth 8. The teeth are triggered to pivot outwardly and slot into matching recesses 11 formed in the drive motor 2, as shown in FIG. 1(b), with lower faces of the teeth resting on base surfaces of the recesses. The weight of the control rod 1 is thereby carried by the motor, such that operation of the motor produces movement of the control rod 1.

Above the threshold pressure, the actuator rod 3 remains retracted, keeping the teeth 8 pivoted outwards and maintaining the operative connection of the drive motor 2 and the control rod 1. If the pressure falls below the threshold pressure, however, the resulting increase in the volume 6 of the gas and upwards movement of the actuator rod 3 moves the angled side faces of the actuator rod away from the follower faces of the engagement teeth, which can return to their retracted position under the action of respective return springs (not shown).

The connection mechanism thus enables the introduction of an internal control rod drive motor into a reactor. In particular, outside intervention to connect the control rod 1 to the drive motor 2 can be avoided, thus reducing build and refueling outage durations whilst reducing risks arising from human error.

The connection mechanism is mechanically simple, requiring no external supplies and no additional instrumentation, and can operate reliably for as long as structural integrity can be maintained. It relies on the ambient pressure in the reactor passing the threshold value to connect/disconnect. At manufacture, the connection mechanism can be set to its disengaged position and the volume 6 of gas trapped (at ambient pressure) and then sealed. By suitable positioning and shaping of the actuator rod 3 and the engagement teeth 8, and suitable selection of the strength of the spring 8 and of the size and pressure of the volume of trapped gas, the threshold value and reaction time of the mechanism can be adjusted.

The seal provided the bellows 7 can be designed to withstand the reactor operating pressure. Once installed, the connection mechanism controls connection/disconnection of the control rod 1 to the drive motor 2 by changes in reactor pressure alone.

The connection mechanism can also provide the following benefits:
1. Shut-down safety can be improved because it is not possible to operate the control rods when the system pressure is below the threshold pressure, i.e. the mechanism provides “revealed failure”.
2. Failure of the connection mechanism in-service (e.g. a broken seal) can be made fail-safe because the affected control rod cannot be withdrawn from the reactor core, or will be re-inserted automatically.
3. The possibility of control rod “hang-up” when removing a control rod drive motor can be identified by monitoring the mass of the lift.
4. In the event of an accident, reactor vessel depressurisation causes the control rod to be released from the control rod drive motor, leading to automatic rod re-insertion into the reactor core, i.e. the mechanism contributes to “defense-in-depth”.

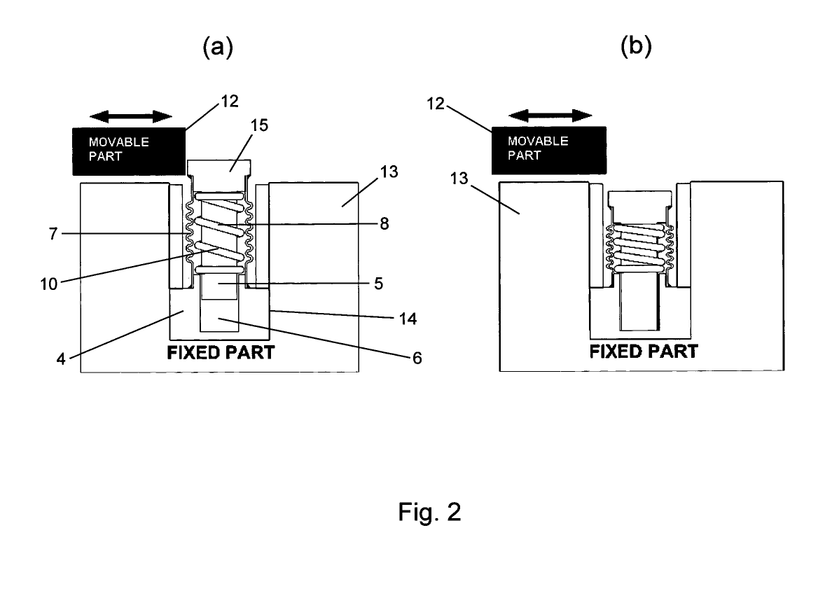

The pressure sensing arrangement of the above connection mechanism can be used in other devices. For example, FIG. 2 shows schematically a locking mechanism for locking a hatch 12 which closes an opening in a pressurised bulkhead 13, the mechanism being shown in (a) a locked position and (b) an unlocked position. In FIGS. 1 and 2 corresponding features have the same reference numbers. In FIG. 2, the mechanism is mounted to the bulkhead, although it can equally be mounted to the hatch.

The pressure sensing arrangement of the locking mechanism is again provided by a cylinder 4, a piston 5 positioned in the cylinder, and a volume 6 of gas located between faces of the cylinder and the piston. A bellows 7 extends between the piston and the outer wall of the cylinder, which is fixed in a recess 14 in the bulkhead 13, to trap the volume of gas in the cylinder. The piston is slidably movable in the cylinder in the axial direction of the control rod. A spring 10 biases the piston 5 in the direction which produces an increase in the size of the volume of trapped gas.

In this case, however, rather than having an actuator rod at the distal end of the piston 5, a simple bolt 15 at the distal end serves as a lock. When the ambient pressure is below the threshold pressure, as shown in FIG. 2(a), the piston is extended such that the bolt 15 projects out of the recess 14 to prevent movement of the hatch 12 and lock it in a closed position. As the ambient pressure increases, the volume 6 of the trapped gas decreases, drawing the piston into the cylinder 4 until the threshold pressure is reached, as shown in FIG. 2(b), at which point the bolt 15 is retracted sufficiently into the recess to allow the hatch to open.

Such a locking mechanism can be employed as a safety feature on doors, hatches or other closures in high-pressure environments, such as deep sea submersibles. The locking mechanism can be incorporated into nuclear reactor fuel modules to prevent unplanned movement of control rods during transportation, installation and removal.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting.

1-10. (canceled)

11. A connection mechanism for operatively connecting a reactor control rod to a drive motor, the connection mechanism being mountable to the reactor control rod and including:
a pressure sensitive actuator comprising an actuator member and a pressure sensing arrangement which senses the ambient pressure and moves the actuator member in response thereto and an engagement device which is activatable by movement of the actuator member to engage with the drive motor.

12. A connection mechanism according to claim 11 in which the actuator member and the engagement device are configured such that the engagement device is activated by movement of the actuator member when the ambient pressure exceeds a threshold pressure.

13. A connection mechanism according to claim 11 in which the actuator member includes an actuator rod having one or more angled side faces, the actuator rod being movable in its axial direction such that the side faces bear against one or more corresponding follower faces of the engagement device to move the engagement device into engagement with the drive motor.

14. A connection mechanism according to claim 11 in which the engagement device comprises one or more engagement teeth which are outwardly extendable to engage with the drive motor.

15. A connection mechanism according to claim 11 in which the engagement device is deactivatable by movement of the actuator member in the opposite direction to disengage from the drive motor and thereby to operatively disconnect the reactor control rod from the drive motor.

16. A connection mechanism as claimed in claim 11 in which the pressure sensing arrangement includes a cylinder, a piston operatively connected to the actuator member, and a volume of gas which is trapped between the cylinder and the piston, the gas being compressed by increases in ambient pressure thereby drawing the piston into the cylinder to in turn move the actuator member.

17. A connection mechanism as claimed in claim 16 in which the piston is spring-loaded in the cylinder to bias the piston against movement in the cylinder produced by increases in ambient pressure.

18. A connection mechanism as claimed in claim 16 in which the volume of gas is trapped between the cylinder and the piston by a bellows arrangement.

19. A connection mechanism as claimed in claim 17 in which the volume of gas is trapped between the cylinder and the piston by a bellows arrangement.
